(19) United States
(12) Patent Application Publication
(10) Pub. No.: US 2025/0317419 A1
(43) Pub. Date: Oct. 9, 2025

(54) SECURITY VPC SECURITY INSPECTION ORCHESTRATION AND ABSTRACTIONS FOR ALL CSPS

(71) Applicant: Cisco Technology, Inc., San Jose, CA (US)

(72) Inventors: Ganesh Narayanaswamy, Sunnyvale, CA (US); Praveen Kumar Patnala, Santa Clara, CA (US); Sreenivasa Kiran Madabhushi, San Jose, CA (US); Vijay Chander, San Ramon, CA (US)

(21) Appl. No.: 18/626,170

(22) Filed: Apr. 3, 2024

Related U.S. Application Data
(60) Provisional application No. 63/609,196, filed on Dec. 12, 2023.

(51) Int. Cl. H04L 9/40

(52) U.S. Cl. CPC H04L 63/0227

(57) ABSTRACT

A network device may receive one or more first user inputs in a security gateway creation user interface (UI) provided by a controller. A network device may query, by the controller, the CSP using Application Programming Interfaces (APIs) to retrieve information about applications within the at least one virtualized network environment including any services deployed within the at least one virtualized network environment. A network device may present a security status user interface that identifies the at least one virtualized network environment applications configured in the CSP account and a respective status indicating whether the at least one virtualized network environment is protected by the security gateway. A network device may receive a second user input within the security status user interface, the second user input is effective to enable protection of the at least one virtualized network environment by the security gateway.

### FIELD OF THE TECHNOLOGY

The present technology relates to the field of network communication, specifically addressing security gateways for cloud-based applications and workloads. More particularly, the proposed technology discloses methods for optimizing security services for cloud applications based on deep content inspection and address restriction.

### BACKGROUND

Public clouds are third-party, off-premises cloud platforms that deliver computing resources, such as virtual machines, storage, and applications, over the internet. Services provided by public cloud providers, such as Amazon Web Services (AWS), Microsoft Azure, and Google Cloud Platform, are shared among multiple customers. Public clouds offer scalability, cost efficiency, and flexibility as organizations can access and pay for resources on a pay-as-you-go model. Pay-as-you-go is particularly beneficial for customers with fluctuating workloads and enabling enterprises to scale resources up or down based on demand. However, the shared nature of public clouds raises considerations regarding security, compliance, and data privacy, and customers need to carefully evaluate their specific requirements and choose appropriate providers.

Many customers also have private clouds, which is dedicated infrastructure that is either on-premises or hosted by a third-party. Private clouds are designed exclusively for a single customer, providing greater control over resources and data. Private clouds are suitable for entities with stringent security and compliance requirements, allowing the entities to customize and manage the infrastructure according to specific needs. Entities use private clouds to retain control over important business applications, sensitive data, or when regulatory compliance mandates demand a higher level of data governance.

Hybrid and multi-cloud approaches have become popular to adapt the benefit of public and private clouds. Hybrid clouds allow organizations to enjoy the scalability of public clouds while retaining certain workloads in a private, more controlled environment. Multi-cloud strategies involve using services from multiple public cloud providers, offering redundancy, flexibility, and the ability to choose the best-suited services for specific tasks.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate some typical aspects of this disclosure and are therefore not to be considered limiting of its scope. Other features, aspects, and advantages will become apparent from the description, the drawings, and the claims.

FIG. 1 is a conceptual diagram of a cloud security platform that integrates into different cloud providers in accordance with some aspects of the disclosure.

FIG. 2 is a conceptual diagram of a controller of a cloud security platform that integrates into different cloud service providers in accordance with some aspects of the disclosure.

FIG. 3 illustrates a functional view of a data path pipeline and integration with hardware in accordance with some aspects of the disclosure.

FIG. 4 illustrates a data path pipeline for forward packet flows and proxy packet flow of a cloud security platform in accordance with some aspects of the disclosure.

FIG. 5 is a conceptual diagram illustrating a cloud security platform integrated into a multi-cloud service in accordance with some aspects of the disclosure.

FIG. 6A-6C illustrates an example multi-cloud defense architecture in accordance with some aspects of the disclosure.

FIG. 7 illustrates a user interface for setting up a CSP with a multi-cloud defense controller in a cloud security platform in accordance with some aspects of the disclosure.

FIG. 8 illustrates a user interface for adding a security VPC in the cloud security platform in accordance with some aspects of the disclosure.

FIG. 9 illustrates an example dashboard providing an inventory of VPCs managed by the cloud security platform in accordance with some aspects of the disclosure.

FIG. 10 illustrates a process for creating a security gateway in a cloud service provider (CSP), in accordance with one embodiment.

FIG. 11 illustrates an example computing system, which can be for example any computing device that can implement components of the system, in accordance with some examples of the disclosure.

### DETAILED DESCRIPTION

Various embodiments of the disclosure are discussed in detail below. While specific implementations are discussed, it should be understood that this is done for illustration purposes. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims or may be learned by the practice of the principles set forth herein.

### Overview

The present disclosure is directed toward a security gateway for platform as a service (PaaS) that offers an advanced layer of security to fortify the existing measures provided by cloud platform providers. The disclosed technology discloses a gateway that leverages sophisticated techniques, such as deep content inspection and address restriction, to enhance the protection of resources within the cloud service infrastructure.

In one aspect, the techniques described herein relate to a method for creating a security gateway in a cloud service provider (CSP), including: receiving one or more first user inputs in a security gateway creation user interface (UI) provided by a controller, wherein the one or more first user inputs include account information for a CSP account and a region within the CSP in which the CSP account has deployed at least one virtualized network environment, wherein the CSP can be any public cloud provider, wherein the virtualized network environment is a virtual private cloud (VPC) or virtual network (VNet), wherein the security gateway creation user interface is configured to present a consistent user interface irrespective of which public cloud provider host the CSP account; generating a security gateway within the region of the CSP using the received inputs; querying, by the controller, the CSP using Application Programming Interfaces (APIs) to retrieve information about applications within the at least one virtualized network environment including any services deployed within the at least one virtualized network environment; presenting a security status user interface that identifies the at least one virtualized network environment applications configured in the CSP account and a respective status indicating whether the at least one virtualized network environment is protected by the security gateway; and receiving a second user input within the security status user interface, the second user input is effective to enable protection of the at least one virtualized network environment by the security gateway, wherein the second user input triggers controller to configure the at least one virtualized network environment to create a connection to the security gateway and update routing tables to direct traffic to the security gateway, wherein the controller interacts with one or more APIs appropriate for the respective CSP that is hosting the at least one virtualized network environment to configure the respective CSPs particular type of interconnection of virtualized network environment, for example, AWS utilizes a transit gateway, Azure utilizes VNet Peering, GCP utilizes VPC Peering.

In some aspects, the techniques described herein relate to a method, wherein the security status user interface further categorizes the at least one virtualized network environment into multiple gateway zones based on their functional dependencies or security requirements, allowing users to selectively apply security policies to respective virtualized network environments within specific zones.

In some aspects, the techniques described herein relate to a method, further including detecting, through continuous monitoring of the CSP account, data originating from a new virtualized network environment not previously identified in the security gateway; presenting the new virtualized network environment in the security status user interface as not protected along with an option to protect the new virtualized network environment.

In some aspects, the techniques described herein relate to a method, further including: detecting, through continuous monitoring of the CSP account, data originating from a new virtualized network environment not previously identified in the security gateway; automatically, without further user interaction, enabling protection of the new virtualized network environment by the security gateway, wherein the controller configures the new virtualized network environment to create a second connection to the security gateway and update routing tables to direct traffic to the security gateway.

In some aspects, the techniques described herein relate to a method, wherein the querying the CSP to retrieve information about the at least one virtualized network environment includes retrieving information about an application hosted within the at least one virtualized network environment.

In some aspects, the techniques described herein relate to a method, further including: monitoring the CSP to dynamically to learn of changes in the status of the application, the at least one virtualized network environments, and new applications and new virtualized network environments within the CSP account; and updating the security status user interface with the changes in the status and the new applications and new virtualized network environments.

In some aspects, the techniques described herein relate to a method, further including: presenting the application in the security status user interface as not protected along with an option to protect the application, wherein the application needs to be within a protected virtualized network environment in order to be protected by the security gateway; receiving an input by the security status user interface to associate the application with a security policy, whereby network traffic to and from instances of the application will be inspected by the security gateway according to the security policy.

In some aspects, the techniques described herein relate to a method, wherein the security policy assigned to the active application is determined by evaluating the security information provided by the active application, taking into account factors such as data sensitivity, communication protocols, and one or more security vulnerabilities.

In some aspects, the techniques described herein relate to a method, wherein the first user inputs for the CSP account includes CIDR blocks, and availability zones in addition to the authentication credentials and region.

In one aspect, the techniques described herein relate to a network device including: a transceiver; a processor configured to execute instructions and cause the processor to: receive one or more first user inputs in a security gateway creation user interface (UI) provided by a controller, wherein the one or more first user inputs includes account information for a CSP account and a region within the CSP in which the CSP account has deployed at least one virtualized network environment, wherein the CSP can be any public cloud provider, wherein the virtualized network environment is a virtual private cloud (VPC) or virtual network (VNet), wherein the security gateway creation user interface is configured to present a consistent user interface irrespective of which public cloud provider host the CSP account; generate a security gateway within the region of the CSP using the received inputs; query, by the controller, the CSP using Application Programming Interfaces (APIs) to retrieve information about applications within the at least one virtualized network environment including any services deployed within the at least one virtualized network environment; present a security status user interface that identifies the at least one virtualized network environment applications configured in the CSP account and a respective status indicating whether the at least one virtualized network environment is protected by the security gateway; and receive a second user input within the security status user interface, the second user input is effective to enable protection of the at least one virtualized network environment by the security gateway, wherein the second user input triggers controller to configure the at least one virtualized network environment to create a connection to the security gateway and update routing tables to direct traffic to the security gateway, wherein the controller interacts with one or more APIs appropriate for the respective CSP that is hosting the at least one virtualized network environment to configure the respective CSPs particular type of interconnection of virtualized network environment, for example, AWS utilizes a transit gateway, Azure utilizes VNet Peering, GCP utilizes VPC Peering.

In one aspect, the techniques described herein relate to a non-transitory computer readable medium including instructions, the instructions, when executed by a computing system, cause the computing system to: receive one or more first user inputs in a security gateway creation user interface (UI) provided by a controller, wherein the one or more first user inputs includes account information for a CSP account and a region within the CSP in which the CSP account has deployed at least one virtualized network environment, wherein the CSP can be any public cloud provider, wherein the virtualized network environment is a virtual private cloud (VPC) or virtual network (VNet), wherein the security gateway creation user interface is configured to present a consistent user interface irrespective of which public cloud provider host the CSP account; generate a security gateway within the region of the CSP using the received inputs; query, by the controller, the CSP using Application Programming Interfaces (APIs) to retrieve information about applications within the at least one virtualized network environment including any services deployed within the at least one virtualized network environment; present a security status user interface that identifies the at least one virtualized network environment applications configured in the CSP account and a respective status indicating whether the at least one virtualized network environment is protected by the security gateway; and receive a second user input within the security status user interface, the second user input is effective to enable protection of the at least one virtualized network environment by the security gateway, wherein the second user input triggers controller to configure the at least one virtualized network environment to create a connection to the security gateway and update routing tables to direct traffic to the security gateway, wherein the controller interacts with one or more APIs appropriate for the respective CSP that is hosting the at least one virtualized network environment to configure the respective CSPs particular type of interconnection of virtualized network environment, for example, AWS utilizes a transit gateway, Azure utilizes VNet Peering, GCP utilizes VPC Peering.

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### Example Embodiments

Cloud network providers include various companies such as Google, Apple, Amazon, Microsoft, DigitalOcean, Vercel, Alibaba, Netlify, Redhat OpenShift, Oracle, and many other entities. Each cloud provider offers a range of services, from foundational infrastructure, which is referred to Infrastructure as a Service (IaaS), platforms for application development and deployment, which is referred to as platform as a service (PaaS), and fully managed software applications, which is referred to as software as a service (SaaS). Cloud providers maintain a network of geographically distributed data centers that host servers, storage, and networking equipment and allowing customers to deploy resources in proximity to their target audience for improved performance and redundancy, including content delivery networks (CDN) and edge compute services.

Virtualization technology is a foundational aspect of cloud providers and enable the creation of virtual instances of servers, storage, and network resources within a geographic region. Cloud providers also deploy resource orchestration tools manage the dynamic allocation and scaling of these virtual resources based on demand. Fundamentally, cloud providers establish robust, high-speed connections between their data centers and forming a global network backbone. This backbone ensures low-latency communication and facilitates data transfer between different regions.

Conventional security within cloud providers deploy a range of security measures, including encryption, firewalls, identity and access management, and compliance certifications, to safeguard customer data and ensure the integrity of their services. Cloud services are designed to be elastic, allowing customers to dynamically scale resources up or down based on demand to handle varying workloads efficiently.

Cloud providers offer various managed services, such as databases, machine learning, and analytics, runtimes, and other aspects that allow customers to leverage advanced functionalities without the need for deep expertise in those domains. Various application programming interfaces (APIs) can be exposed by a cloud provider that enable users to programmatically interact with, manage their resources, and allow integration with third-party tools and the automation of various tasks.

Fundamentally, in past server architectures, a server was defined with a fixed internet protocol (IP) address. In cloud-based computing, IP addresses are dynamic and enable the resources within the cloud providers. Cloud environments include dynamic scaling to accommodate varying workloads and dynamic IP addresses allow for the automatic allocation and release of addresses as resources are provisioned or de-provisioned. The dynamic addresses also allow service elasticity to respond to increasing or decreasing resources, cost efficiently, automation and orchestration of tools within the cloud integration and deployment environment, load balancing, high availability and failover, adaptable network topology, and increase resource utilization.

Cloud security is a fundamental issue as customers typically may deploy resources and integrate into resources of different cloud providers. While the clouds have a generic infrastructure configuration with a spine network topology that routes traffic to a top-of-rack (TOR) switch and servers within the racks, clouds are still configured differently and have different requirements. For example, some cloud providers are emphasizing different geographical markets, cloud providers can emphasize different business segments (e.g., healthcare, government, etc.), and configure services according to their intended market.

Cloud security has become an important aspect of networking today because there are significant challenges. For example, data breaches are a significant concern in the cloud because unauthorized access to sensitive data, either through misconfigurations or cyberattacks, can lead to data exposure, and compromise the confidentiality of information. Misconfigurations of cloud services, such as incorrectly configured access controls or insecure storage settings, can create vulnerabilities and may expose data to unauthorized users or attackers.

Another important aspect of cloud security is identity management. Improper management of user identities and access privileges can result in unauthorized access. Inadequate or improperly implemented encryption can lead to data exposure. This includes data in transit, data at rest, and data during processing. Ensuring end-to-end encryption is crucial for maintaining data confidentiality.

Cloud providers use shared infrastructure and technologies. If a vulnerability is discovered in a shared component, multiple clients could be affected simultaneously. Regular security updates and patches are essential to mitigate this risk, and there is an increased market for third-party services that integrate into cloud provider services.

Organizations may fail to conduct thorough due diligence when selecting a cloud service provider. Inadequate assessment of a provider's security measures, compliance standards, and data protection practices can result in security gaps.

The evolving landscape of cybersecurity introduces new threats and attack vectors. Cloud security solutions continuously adapt to address emerging threats, such as zero-day vulnerabilities and advanced persistent threats (APTs). These attacks can come from many different sources, and monitoring these threats can be too difficult for entities.

The cloud is dynamic, connected, and encrypted. Customers of cloud providers primarily care about their business operations and not the infrastructure behind the business operations. In the current environment, customers of cloud service providers need to implement instruction protection services (IPS), instruction detection services (IDS), web application firewalls (WAF), as well as provide egress security. Customers may also need to implement data loss prevention services (DLP) to comply with sensitive information requirements.

Multi-cloud deployments involve organizations utilizing multiple cloud service providers (CSPs) simultaneously, providing flexibility and redundancy in their infrastructure. However, the complexity of managing security across these diverse environments presents a significant challenge. Configuring centralized virtual private cloud (VPC) inspection services, particularly for tasks like egress traffic flow protection, currently includes a manual and labor-intensive process. While CSPs offer templates for configuring such services, customers are still required to manually deploy and manage security VPCs, resulting in complexities and potential inconsistencies.

This manual configuration approach not only consumes valuable time and resources but also introduces the risk of errors and discrepancies across cloud environments. Furthermore, it impedes scalability and agility, limiting organizations' ability to adapt to evolving security requirements or seamlessly scale their infrastructure across multiple CSPs.

Addressing these challenges necessitates a more efficient and standardized approach to managing security VPCs. By automating the creation and configuration of centralized VPC inspection services through a cloud-agnostic user interface (UI) and application programming interface (API) abstraction layer, organizations can alleviate the complexities associated with manual setup. This automation not only streamlines deployment processes but also ensures consistent security measures are applied across diverse cloud environments. Ultimately, this approach enhances operational efficiency and strengthens overall security posture in multi-cloud deployments.

The proposed technology discloses methods for automating the creation and configuration of centralized VPC inspection services through a cloud-agnostic UI and API abstraction layer, organizations can mitigate the complexities associated with manual setup. This not only streamlines deployment processes but also ensures consistent security measures across diverse cloud environments, ultimately enhancing operational efficiency and bolstering overall security posture in multi-cloud deployments.

The proposed technology offers a unified and consistent interface for managing the creation and configuration of Virtual Private Clouds (VPCs), and serves as an orchestration tool, streamlining the setup of security VPCs and automating the provisioning of associated resources. Through an Application Programming Interface (API) layer, the technology facilitates seamless integration with various Cloud Service Providers (CSPs), enabling automated orchestration and configuration of resources across multiple platforms.

At its core, the interface provided by this technology encompasses two primary actions. Firstly, the interface enables the instantiation of security VPCs, by a controller, allowing users to easily define and deploy the network infrastructure and security components. This step ensures that the foundational elements of the security VPC are established in a consistent and standardized manner, regardless of the underlying CSP or cloud environment.

Secondly, the interface facilitates, via the controller, the assignment of security VPCs to workload VPCs. By linking security VPCs to specific workload environments, users can efficiently enforce security policies and controls tailored to the requirements of individual workloads. This granular approach enables organizations to implement targeted security measures while maintaining flexibility and scalability in their infrastructure.

The proposed technology further entails a method for the creation of a security gateway within a cloud service provider (CSP), involving several distinct steps. Initially, the method involves receiving various user inputs through a user interface (UI), which encompasses essential user information related to a designated user account within the CSP, along with specific settings to be associated with the CSP.

Subsequently, the method entails the automatic generation of a security gateway in the VPC regardless of which CSP is used to host the VPC, leveraging the inputs received earlier. This process ensures the efficient establishment of a security infrastructure aligned with user preferences and requirements. Following this, the method involves the controller querying the CSP through Application Programming Interfaces (APIs) to gather comprehensive information about the services and applications within the VPC, specifically linked to the user account.

Once the relevant information is obtained, the method presents an intuitive interface detailing the configured services and applications within the security gateway, along with their respective protection statuses. Additionally, the interface highlights active applications detected within the gateway, providing users with valuable insights into the security posture of their environment. Users are then empowered to protect active applications by associating them with the security gateway, triggering prompts for network and security information to facilitate protective actions.

Upon receiving this input, the security gateway diligently identifies an appropriate security policy based on the provided network and security information. This policy assignment ensures that each application receives tailored protection aligned with its specific requirements and potential threats. Moreover, the method enables proactive threat detection by applying the security policy to incoming data and identifying threat signatures necessitating updates.

In response to detecting such threat signatures, the method dynamically generates updated security policies incorporating configuration changes to address emerging threats effectively. These updates are automatically applied to the security gateway, ensuring real-time protection for the active application against evolving security risks. Ultimately, this method ensures the continuous enhancement of security measures and the seamless application of protective policies to safeguard applications within the CSP environment.

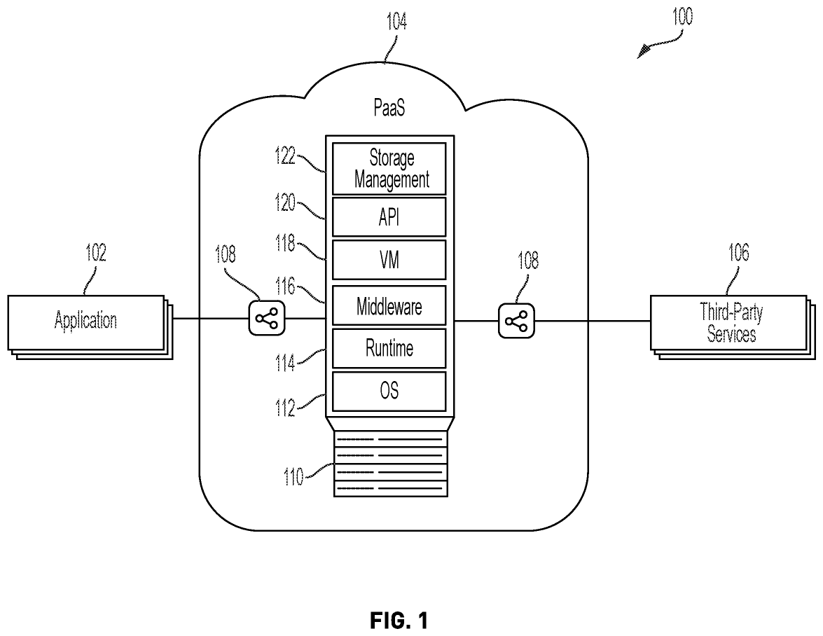

FIG. 1 is a conceptual diagram of a networking environment 100 associated with a cloud security platform that integrates into different cloud providers according to some aspects of the disclosure. In some aspects, the networking environment 100 includes a plurality of applications 102 that are connected to a cloud security platform 104 that is configured for various aspects of cloud security. The cloud security platform 104 comprises a compute layer that is configured to discover applications and network resources, deploy cloud-based firewalls and management, and provide multi-cloud policy and control from a single end point.

The applications 102 include various forms, such as distributed cloud-based applications, edge-based applications (e.g., webapps), desktop-based applications, mobile phone applications, and so forth. The third-party services 106 include various services, such as cloud service providers and other services that are integrated into the cloud security platform 104. For example, the cloud security platform 104 may be configured to use different services for specialty functions that are consistent for each customer of the cloud security platform 104. Non-limiting examples of a different services include various types of communication services (e.g., mail servers, communication platforms, etc.), security-oriented services (e.g., monitoring services such as Splunk), search services, storage services (e.g., relational databases, document databases, time-series databases, graph databases, etc.), authentication services, and so forth.

The cloud security platform 104 is configured to be deployed within various infrastructure environments in a PaaS manner. The cloud security platform 104 includes networking infrastructure 108 for connecting the application 102 to the cloud security platform 104. The cloud security platform 104 includes a plurality of servers 110 that are geographically distributed, with each server being managed by with various operating systems (OS) 110, runtimes 114, middleware 116, virtual machines (VM) 118, APIs 120, and management services 122. In some aspects, the cloud security platform 104 includes a runtime 114 refers to the environment that the middleware 116 will execute within to control various aspects of the cloud security platform 104. For example, the VMs 118 may be Kubernetes containers and the middleware 116 may be configured to add or remove hardware resources within cloud providers dynamically.

The cloud security platform 104 also exposes one or more APIs 120 for allowing the applications 102 to interact with the cloud security platform 104. The APIs 120 enable a customer to surface information, interact with information within the cloud security platform 104, and perform other low-level functions to supplement security services of the cloud security platform 104. The API 120 is also configured to integrate with other, third-party services (e.g., the third-party service 106) to perform various function. For example, the API 120 may access a customer's resources in a cloud service provider (e.g., a third-party service 106) to monitor for threats, analyze configurations, retrieve logs, monitor communications, and so forth. In one aspect, the API 120 is integrating with third-party cloud providers in an agnostic manner and allows the cloud security platform 104 to perform functions dynamically cross cloud providers. For example, the API 120 may dynamically scale resources, allow resources to join a cluster (e.g., a cluster of controller instances), implement security rules from the cloud security platform 104 into the corresponding cloud provider, and other functions that enable a cloud agnostic and service agnostic integrated platform. For example, in some cases, the API 120 is configured to integrate with other security services to retrieve alerts pertaining to specific assets to reduce exposure to malicious actors.

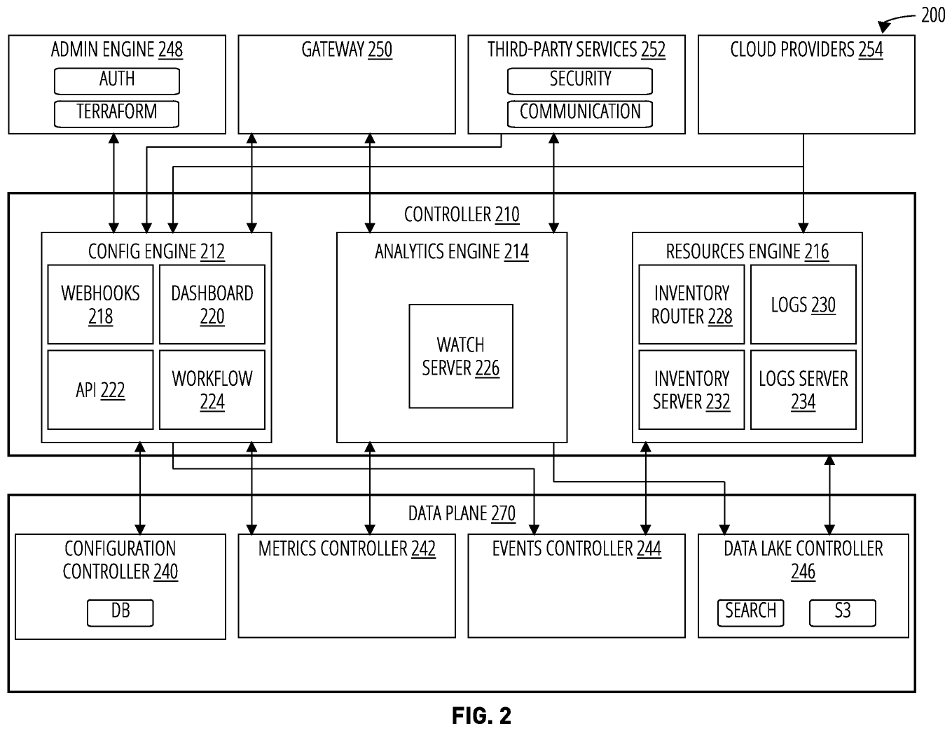

The cloud security platform 104 also includes management services 122 for managing various resources of a customer. In some aspects, the management services 122 can manage resources including a controller (e.g., the controller 210 in FIG. 2), data resources (e.g., a data plane 270 in FIG. 2), and various integrations (e.g., a gateway 250, third-party services 252, cloud providers 254 in FIG. 2). For example, the management services 122 may allow the customer to manage various third-party resources such as a cloud-based relational database, a cloud-based document database, a cloud-based storage service (e.g., various implementations of the S3 API) and so forth.

In one aspect, the management services 122 include an onboarding user experience that connects to various cloud providers (e.g., using the API 120) and allows onboarding of different cloud resources. The management services 122 also provides a cloud-agnostic approach to managing resources across different cloud providers, such as scaling up identical resources in different regions using different cloud providers. As an example, some cloud providers do not have a significant presence in the far east, and the management services 122 are configured to activate similar resources in a first geographical region (e.g., in Europe) and a second geographical region (e.g., Asia) with similar configurations in different cloud providers.

The cloud security platform 104 is configured to provide security across and within cloud providers in different contexts. For example, the cloud security platform 104 provides protection and security mechanisms in different flows. The cloud security platform 104 is configured to provide varying levels of protection based on flow, packet, encryption, and other mechanisms. In one aspect, the cloud security platform 104 is configured to protect forwarding flows and packet flows.

Forwarding flow refers to the set of rules and decisions that determine how network devices handle incoming packets without inspecting packet and traffic contents. A forwarding flow involves making decisions based on information such as destination IP address, media access control (MAC) address, and routing tables to determine the outgoing interface for the packet and typically includes actions like address resolution (e.g., ARP for IP to MAC address mapping), updating MAC tables, and forwarding the packet to the appropriate interface, and various rules to apply based on configuration and policies.

A proxy flow comprises both forward proxy and reverse proxy function and inspects content of encrypted flow and access control. In some aspects, the cloud security platform 104 decrypts encrypted traffic to ensure malicious actors are not exploiting vulnerabilities in TLS-encrypted applications, and prevents data exfiltration (e.g., DLP) or connection to inappropriate URLs.

The cloud security platform 104 is also configured to handle packets differently based on security, such as policies related to IPS and a web application firewall (WAF). WAF protects various web application from online threats, such as SQL injection, cross-site scripting (XSS), authentication spoofing, and other potential security. For example, a WAF filters and monitors traffic by inspecting headers (e.g., a JSON encoded object in an HTTP header).

The cloud security platform 104 provides real-time discovery of multi-cloud workloads, at-scale, for virtual private clouds (VPCs) and cloud accounts. Real-time discovery also enables finding security gaps and improve defensive posture. The cloud security platform 104 also provides a data plane management using gateways (e.g., the gateway 250 in FIG. 2) that provides self-healing via in-band/transparent diagnostics), seamless upgrade (e.g., no downtime or user intervention), and auto scaling. The cloud security platform 104 may implement a containerized service (e.g., Kubernetes) to enable scale out deployments with a high service level agreement (SLA) without having to maintain network security infrastructure and integrate with cloud-native networking to enable automation of distributed and centralized (hub-n-spoke) architectures for ingress, egress, east-west (including micro segmentation) and hybrid cloud configurations. The cloud security platform 104 maintains traffic within cloud account boundaries and customers retain control of their private encryption keys without needing to share encryption keys with the control plane (e.g., the controller 210 of FIG. 2).

FIG. 2 is a conceptual diagram of a cloud security platform that integrates into different cloud service providers in accordance with some aspects of the disclosure.

In some aspects, the cloud security platform 200 separates compute and data storage functions and enables a multi-tenancy to support different customers while maintaining data separation when needed. For example, the compute components are separated into a controller 210 and data storage components are implemented in a data plane 270. The controller 210 may be a collection of Kubernetes-based services that deploy a low latency connection (e.g., gRPC) to connect various endpoints and enable bidirectional streaming, preventing connection setup and teardown. Each service within the controller 210 scales up or down horizontally based on load.

The controller 210 includes a configuration engine 212, an analytics engine 214, and a resources engine 216. The configuration engine 212 configures the various components and provides various services such as webhooks 218, a dashboard 220, an API 222, and a workflow 224.

In one aspect, the webhooks 218 module is configures asynchronous method of communication between different applications or services in real-time. In a webhook configuration, one application can register an endpoint URL with another, specifying where it should send data when a particular event occurs. When the event triggers, the originating system automatically pushes data to the registered URL, allowing the receiving application to process and act upon the information immediately. In some aspects, the webhooks 218 modules implements to an observer pattern, with a dependent component providing a URL to the observed data source.

The dashboard 220 provides a user experience to a customer of the cloud security platform 104 and provides various integration modules, onboarding platforms, monitoring tools, and other functions for customers to access.

In some aspects, the APIs 222 can be various libraries to interact with various services, either through a dashboard 220 interface, a command line interface (not shown), or other tooling (not shown). The APIs 222 can also be API endpoints of the cloud security platform 104 or an API library associated with a third-party service (e.g., third-party services 252), or APIs associated with the cloud providers 254. In one aspect, the APIs 222 can include an agnostic API library that is configured to interact with the cloud providers 254 using a single API interface to scale resources, responds to security incidents, or other functions. This API 222 can be accessed via a command line interface or may be distributed to customers via various package management services.

The workflow 224 module can be various components that enable a customer to perform various tasks, such as manage specific resources, deploy services, communicate with team members regarding issues, and so forth. For example, the workflow 224 module can interact with the gateways 250 and an administration engine 248 to manage resources, access to resources, and deployment of various resources (e.g., deploy infrastructure with Terraform).

The analytics engine 214 is configured to integrate with gateways 250 and various third-party services 252 to monitor various events, services, and other operations. The 214 includes a watch server 226 that is configured to disambiguate information from multiple sources of information (e.g., the gateway 250, the third-party services 252, etc.) to provide a wholistic view of cloud networking operations. The analytics engine 214 may also be configured to interact with various components of the data plane 270 such as a metrics controller 242 and a data lake controller 246.

In some aspects, the resources engine 216 receives resources from cloud providers 254 and includes various components to route information and store information. The resources engine 216 includes an inventory router 228, logs 230 (e.g., a cache of logs for various function), an inventory server 232, and a logs server 234. The components of the resources engine 216 are configured to disambiguate and combine information in agnostic and standardized manner and store various resources in the data plane 270. For example, the resources engine 216 stores and receives events from an events controller 244 and also sores and receives logs in the data lake controller 246. In some aspects, the inventory router 228 and the inventory server 232 build an evergreen model of the customer's cloud accounts and subscriptions and create an address object for security policy management for the cloud security platform 200. The address object represents a segment of the customer's subscription based on cloud native attributes (e.g., Security Group, ASG, customer-defined tags) and maps to a collection of IP Addresses which is automatically refreshed and synchronized with the gateway 250.

The data plane 270 includes various components to separate various types of information associated with the control plane and interconnected third-party services 252 and cloud providers 254. For example, the data plane 270 includes a configuration controller 240 that stores inventory information of a customer and various configuration information. In one example, the cloud providers 254 use different metrics for decisions pertaining to scaling deployed resources, and the configuration controller 240 stores information that allows the controller 210 to scale resources within the cloud providers 254 in a standardized manner. In some aspects, the configuration controller 240 may include storage mechanisms such as a relational database, a document database, and other high-availability storage mediums. The storage mechanisms can be on-premises resources or off-premises or cloud-based solutions such as various cloud-based relational or document databases (e.g., Redis, MySQL, MongoDB, etc.).

The data plane 270 also includes a metrics controller 242 that is configured to interact with custom metrics data or a third-party service for metrics analysis (e.g., Amazon CloudWatch). The events controller 244 is configured to handle and store events and various queues. For example, the events controller can include a Kafka server for handling real-time data feeds and event-driven applications. The metrics controller 242 may use a publish-subscribe model in which producers (e.g., a third-party service, internal components of the controller 210, a gateway 250, etc.) publish data streams and a consumer subscribes to receive and process these streams in a fault-tolerant and distributed manner. The metrics controller 242 may handle massive amounts of data with low latency and high throughput.

The data lake controller 246 provides a long-term and scalable storage mechanism and associated services. For example, the data lake controller 246 may include a cloud-based S3 API for storing to various cloud services (e.g., AWS, DigitalOcean, OpenShift) or on-premises services (e.g., MinIO, etc.). The data lake controller 246 may also include a search-based mechanism such as ElasticSearch for large-scale and efficient search of contents within the non-volatile cloud storage mechanisms. In some aspects, the data lake controller 246 stores network logs and implement search functionality (e.g., Snowflake) for large scale ad hoc queries for security research and analysis.

The cloud security platform 200 also includes an administration engine 248, a gateway 250, and integrations into various third-party services 106. The administration engine 248 may include authentication services (e.g., Auth0, Okta) to verify identity and provide authentication mechanisms (e.g., access tokens), and may include infrastructure as code (IaC) tools such as Terraform to automate the process of creating, updating, and managing the specified infrastructure across various cloud providers or on-premises environments.

The cloud security platform 200 includes gateways 250 that are deployed into various integration points, such as cloud providers. The gateways 250 an ingress and egress points of the cloud security platform 200 and are configured to monitor traffic, provide information to the controller 210, dynamically scale based on the cloud security platform 200, and provide security to a customer's cloud infrastructure. For example, the gateways 250 may implement a transparent forward and reverse proxy to manage traffic. The gateways 250 may also include a cloud-based firewall that is configured to filter malicious traffic using various dynamic detection policies.

The cloud security platform 200 also integrates into various third-party services 252 for various purposes such as receiving threat-related intelligence (e.g., Spunk, Talos, etc.). The third-party services 252 also include different types of infrastructure components such as managing mobile devices, implementing cloud-based multimedia communication services, business analytics, network analytics (e.g., reverse address lookup), certificate services, security information and event management (SIEM), and so forth.

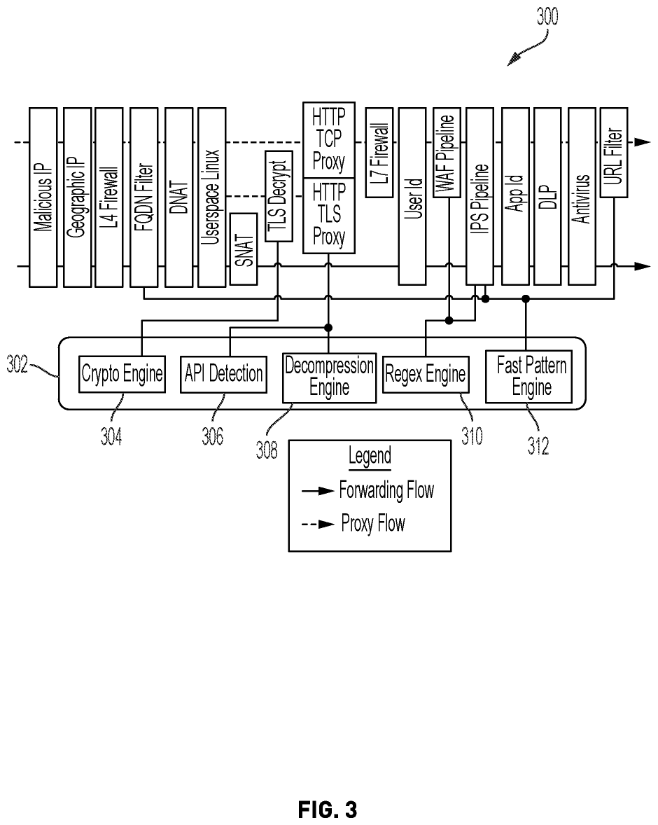

FIG. 3 illustrates a block diagram of a data path pipeline 300 and integration with hardware in accordance with some aspects of the disclosure.

In some aspects, the data path pipeline 300 comprises a single pass firewall architecture that uses a single pass flow without expensive context switches and memory copy operations. In a single pass flow, processing is never duplicated multiple times on a packet. For example, TCP/IP receive, and transmission operations are performed a single time. This is different than existing next generation firewalls (NGFW). The data path pipeline 300 uses fibers with flexible stages completely running in user-space, with no penalty for kernel-user context switches, which are expensive in high bandwidth and low latency operations. The data path pipeline 300 provides advanced web traffic inspection comparable to WAFs to secure all traffic flows and break the attack kill chain in multiple places, raising the economic costs for attackers. The data path pipeline 300 also captures packets of live attacks into a cloud storage bucket without significant performance degradation and enables a rule-based capture on a per-session and attack basis.

The data path pipeline 400 is also configured to be flexible and stages of processing are determined on a per-flow basis. For example, application 1 to application 2 may implement an L4 firewall and IPS inspection, application 3 to application 4 ma implement an L4 firewall, a TLS proxy, and IPS, and an internet client to web application 5 implements an L4 firewall, TLS proxy, IPS, and WAF.

In some aspects, the data path pipeline 300 includes various filters (e.g., malicious IP filter), geographic IP filter, FQDN filter) to filter both forwarding flows and proxy flows, as well as an L4 firewall to restrict traffic based on conventional techniques.

The data path pipeline 300 may also integrated with a hardware offload 302 (e.g., an FPGA of a cloud provider, an ASIC, etc.) that includes additional functionality that does not impact throughput. In one aspect, a cloud providers may offer a hardware offload or an accelerator function to implement specialized function. For example, the hardware offload 302 includes a cryptographic engine 304, an API detection engine 306, a decompression engine 308, a regex engine 310, and a fast pattern engine 312 to offload operations into hardware.

In one aspect, the data path pipeline 300 includes high throughput decryption abd re-encryption to enable inspection of all encrypted flows using the cryptographic engine 304. By contrast, traditional NGFWs provide a throughput of around 10% for inspecting encrypted flows. The data path pipeline 300 may use a decompression engine 308 to decrypt compressed traffic and perform deep packet inspection. For example, the data path pipeline 300 also uses a userspace Linux TCP/IP driver, in addition with network address translation (NAT) in conjunction with the API detection engine 306 and the decompression engine 308 to eliminate problematic and malicious flows.

The data path pipeline 300 includes a transparent reverse and forward proxy to isolate clients and servers without exposing internal details, a layer 7 firewall to rate limit and protect applications and APIs, and secure user access by looking up end-user specific identity from an identity provider (IDP) and provide zero trust network access (ZTNA). The data path pipeline 300 includes a WAF pipeline and an IPS pipeline to detect malicious and problematic flows in conjunction with a regex engine 310 and a fast pattern engine 312. For example, the WAF pipeline may implement protection for web applications, including OWASP Top 10 using core ruleset and application-specific rules for frameworks and common content management tools like PHP, Joomla, and WordPress. The data path pipeline 300 includes IDS and IPS to block known vulnerabilities and provide virtual patching until the applications can be patched with updated security fixes, application identification to block traffic based on client, server or application payload, DLP loss and filtering, URL filtering, antivirus and anti-malware features to prevent malware files from being transferred for ingress (malicious file uploads), east-west lateral attacks (moving toolkits) and egress flows (e.g., botnets

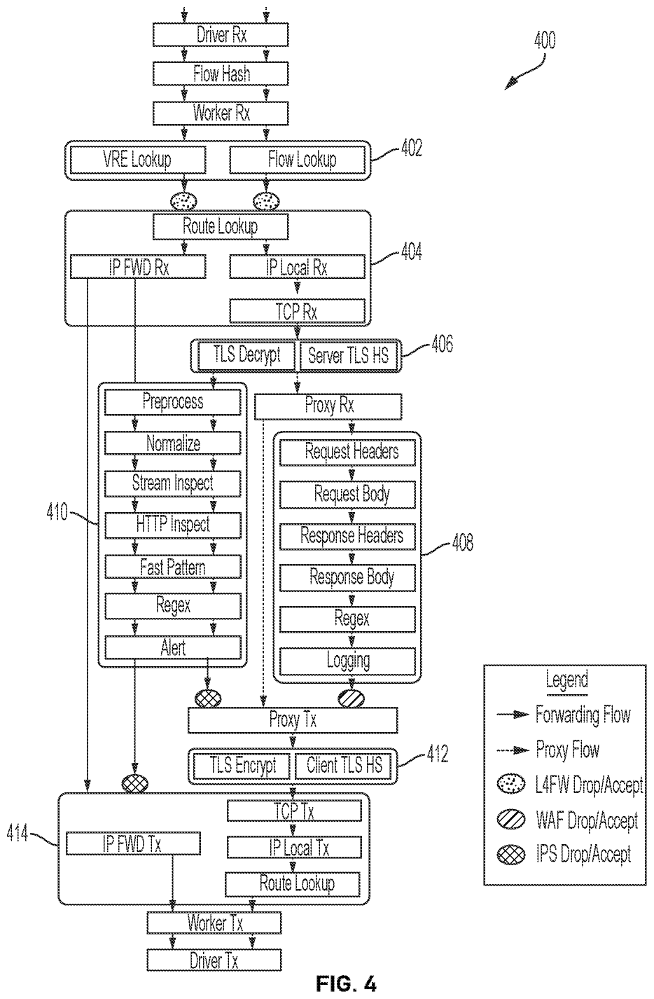

FIG. 4 illustrates a data path pipeline 400 for forward packet flows and proxy packet flow of a cloud security platform in accordance with some aspects of the disclosure.

The data path pipeline 400 comprises a L4 firewall 402, a user space receive TCP/IP stack 404, a TLS receive proxy 406, a WAF 408, an IPS 410, a TLS transmit proxy 412, and a user space transmit TCP/IP stack 414 and illustrates the flow of forwarding flows and proxy flows, and points at which packets may be dropped/accepted using an L4 firewall, a WAF, and/or IPS.

For example, the data path pipeline 400 may be implemented as user space driver (e.g., a data path packet driver (DPDK) that receives forwarding and proxy flows, computes hashes, and provides the packet to the worker. In this case, a worker is part of a distributed instance of a gateway and provides the flows to the 402. For example, the L4 firewall 402, or a transport layer firewall, may be inspect traffic and filter traffic based on source and destination IP/port.

The user space receive TCP/IP stack 404 is configured to perform the receive processing of forwarding and proxy flows. For example, the user space receive TCP/IP stack 404 handles framing, addressing, and error detection within TCP/IP and further identifies per-flow processing based on policies and rules of the cloud security platform. For example, some forwarding flows are provided to the user space transmit TCP/IP stack 414, some forwarding flows are provided to the IPS 410, and proxy flows are forwarded to the TLS receive proxy 406. The TLS receive proxy 406 manages the TLS decryption process in the event further inspection is warranted based on the policies and rules, and then provides the proxy flows to either the IPS 410 or the WAF 408 based on a policy.

The IPS 410 examines its content, headers, and contextual information. Deep packet inspection involves analyzing the payload, looking for patterns, signatures, or anomalies that may indicate malicious activity. The IPS compares the packet against a database of known attack signatures and employs heuristic analysis to detect deviations from expected behavior. Additionally, it assesses factors such as source and destination addresses, ports, and protocol compliance. If the IPS identifies a packet as potentially malicious, it can take proactive measures, such as blocking the packet, alerting administrators, or initiating predefined security policies to prevent the exploitation of vulnerabilities and safeguard the network from intrusion attempts.

The WAF 408 monitors, filters, and analyzes HTTP traffic in real-time and actively look for and blocks common web vulnerabilities such as SQL injection, XSS, and other application-layer attacks. By examining and validating HTTP requests and responses, the WAF can detect and block malicious traffic, ensuring that legitimate requests reach the web application. WAFs often employ rule-based policies, signature-based detection, and behavioral analysis to identify and mitigate potential security risks.

The TLS transmit proxies 412 reassembles the proxy flows and contextual information, and provides the proxy flows the user space transmit TCP/IP stack 414, which reassembles the packet and forwards any traffic. As shown in FIG. 4, flows can be dropped at different points identified in the user space receive TCP/IP stack 404, after the WAF 408 or the IPS 410, or in the user space receive user space transmit TCP/IP stack 414.

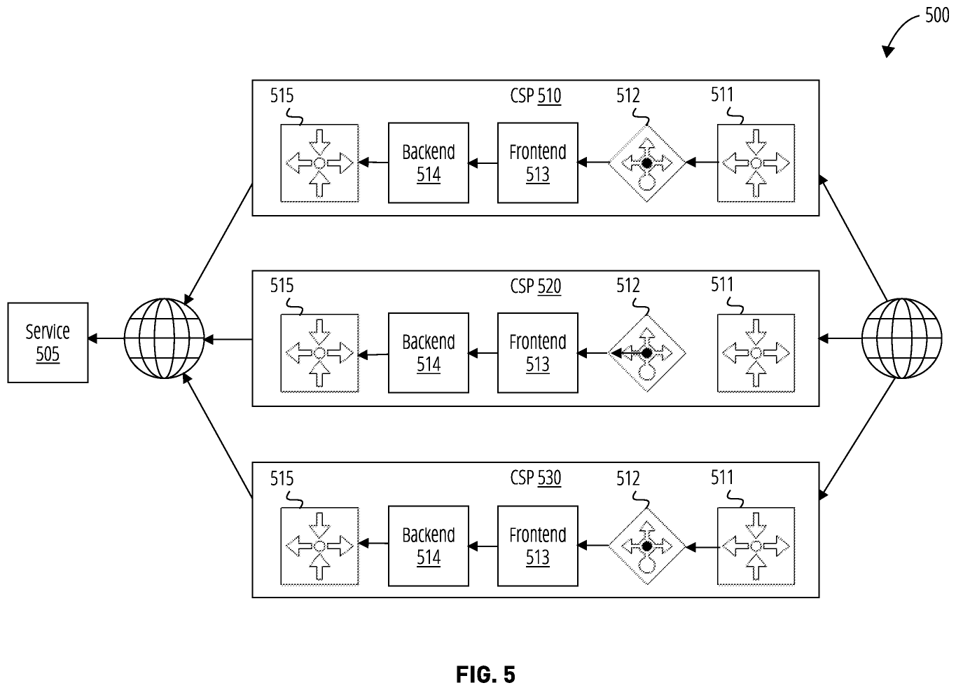

FIG. 5 is a conceptual diagram 500 illustrating a cloud security platform integrated into a multi-cloud service in accordance with some aspects of the disclosure. In some aspects, a service 505 may be geographically distributed and implemented using multiple CSPs. The CSPs can be distributed for many different reasons, for example a particular CSP does not have service available in particular countries. In other aspects, the CSPs may not be distributed geographically to a sufficient extent. Pricing can also be a concern, with lower cost alternatives being available in high-bandwidth region. For at least these reasons, the service 505 may be distributed across CSP 510, CSP 520, and CSP 530 in this example.

Each of the distributed across CSP 510, the CSP 520, and the CSP 530 may include an ingress gateway 511, a load balancer 512, a frontend 513, a backend 514, and an egress gateway 515. In some aspects, the ingress gateway 511 and the egress gateway 515 may be provided by the cloud security platform and provide an agnostic interface to control flows into each different CSP. For example, the cloud security platform can scale resources in a consistent manner, provide malicious content filtering, attack denial, rate limiting, and other services to protect the service 505 at the corresponding CSP. The cloud security platform can also perform the corresponding services to a recipient of the service (not shown).

The cloud security platform abstracts specific details associated with each CSP into a single interface and allows an administrator of the service 505 a common control plane for controlling resources within each CSP and protecting services within each CSP and the service 505.

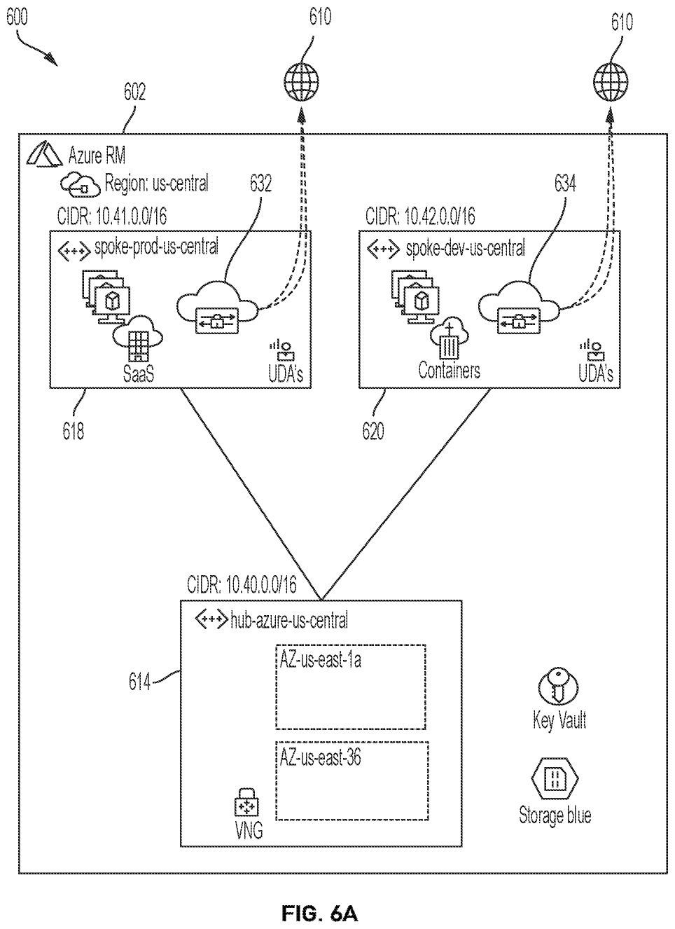

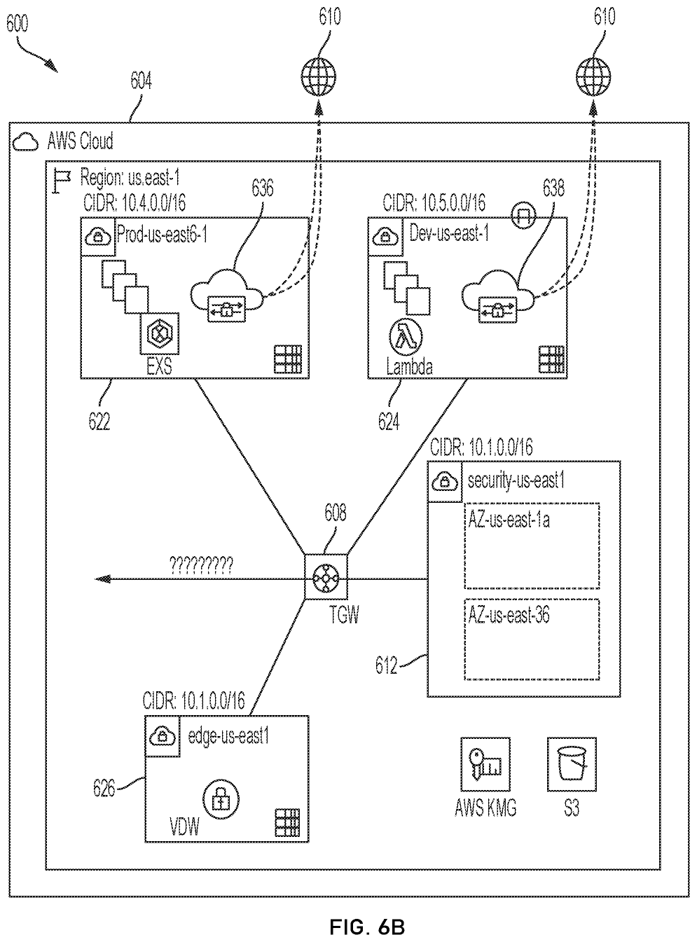

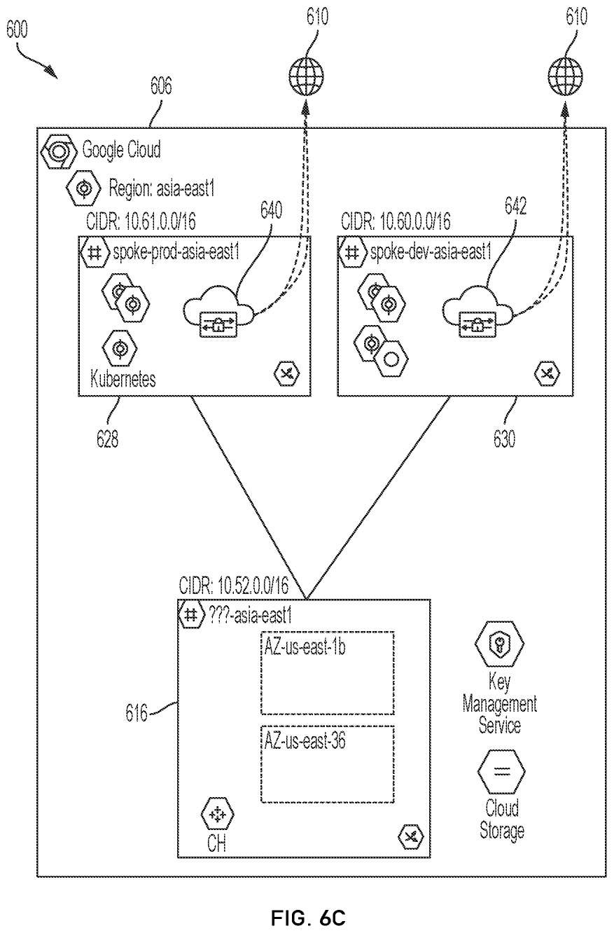

FIG. 6A-6C illustrates an example multi-cloud defense architecture in accordance with some aspects of the disclosure. FIG. 6A-6C depicts a multi-cloud defense architecture designed to streamline and normalize resources across multiple CSPs, while also establishing a uniform API layer spanning these CSPs. This architecture addresses the complexity and fragmentation inherent in managing security across diverse cloud environments by standardizing resource management and communication protocols. By normalizing resources, the architecture enables seamless interoperability and resource allocation across various CSPs, enhancing flexibility and efficiency in cloud management. Additionally, the establishment of a uniform API layer simplifies integration and interaction with cloud services, promoting consistency and ease of use for developers and administrators.

The architecture 600 illustrates a virtual network environment that incorporates multiple CSPs 602, 604, 606. Central to this network is the multi-cloud security controller 644 which serves as an intricately connected component for managing the operations across the various CSPs 602-606. The multi-cloud security controller 644 is responsible for orchestrating the deployment of security gateway instances across the CSPs 602-606, to ensure that consistent security measures, governed by security policies, are in place to safeguard the CSPs 602-606 and applications deployed thereon. Moreover, the multi-cloud security controller 644 is adept at dynamically discovering and securing new applications as they are introduced within each CSP 602-606 and stores data for each CSP in logs stored at the Packet Capture (PCAP) or Syslog, facilitating comprehensive monitoring and analysis of network activity. Additionally, the shared inspection controller is equipped to generate alerts and notifications to one or more connected systems managed by an enterprise. These alerts serve as early warnings for potential security incidents or breaches and to further indicate to an enterprise whether each CSP 602-606 is adequately protected by an assigned security gateway, enabling swift response and mitigation efforts. By seamlessly integrating with enterprise systems, the controller enhances the overall visibility and responsiveness of the security infrastructure, ensuring proactive defense against evolving threats.

Within the architecture 600, each CSP 602-606 is connected to a centralized virtual network 610, and each CSP is delineated into multiple VPCs, serving as isolated portions of their respective CSP infrastructures. These VPCs function as virtualized environments where various resources can be deployed, managed, and isolated from one another within the same CSP. Within each VPC, a diverse array of resources can be provisioned, including applications, virtual machines, databases, and security gateways. For example, CSP 602 includes VPC 618 and VPC 620, each of which include one or more services specific to various functions of CSP 602. CSP 604 includes VPC 622-626, which also includes one or more services specific to CSP 604. Similarly, CSP 606 includes VPC 628 and VPC 630, each of which also includes one or more services specific to CSP 606. CSP 602 and 604 further include security VPC 614 and security VPC 616, respectively.

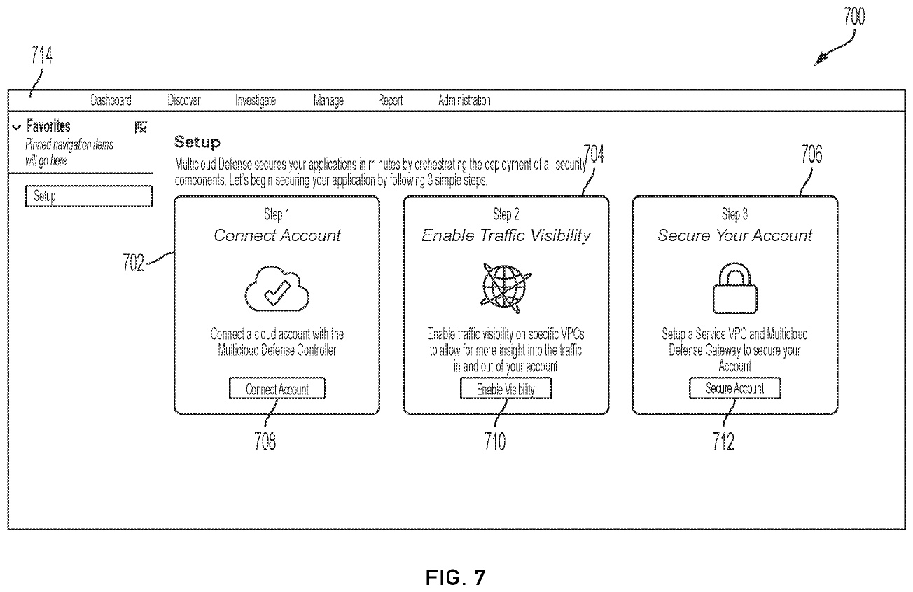

FIG. 6A-6C further extends to the creation of security VPCs 612, 614, and 616, which can be initiated by an enterprise within any of the CSPs 602-606 through an onboarding process elaborated upon in subsequent figures FIG. 7 to FIG. 9. These security VPCs, 612, 614, and 616, are specifically designed to enhance the security posture within the cloud environment. They are configured to deploy a security gateway 632-640 to the VPCs 618-630 residing within the respective CSPs 602-606. The security gateways 632-640 serve as the frontline defense against potential threats and vulnerabilities found in data received from the services associated with each VPC 618-630.

The functionality of the security gateways 632-640 encompasses several responsibilities within CSPs 602-606. Primarily, they receive data transmitted from services hosted within each VPC 618-630 and conduct inspections according to one or more security policies assigned to the respective security gateway concerning the specific service being protected. These security policies dictate the rules and protocols that govern the inspection process, ensuring that data traversing through the network is scrutinized for any signs of malicious activity or unauthorized access attempts. By enforcing these security policies, the security gateways 632-640 play a role in maintaining the integrity, confidentiality, and availability of data within CSPs 602-606.

CSP 604 further includes a transit gateway 608 that serves as a central transit point for network traffic within CSP 604, facilitating seamless communication between VPC 622-626. By consolidating routing and peering relationships, the transit gateway simplifies network connectivity and management, reducing the complexity associated with managing numerous point-to-point connections within CSP 604. Transit gateway 608 receives all traffic originating from the services hosted within each of the VPCs 622-626 by efficiently routing incoming traffic to the respective security gateways 636-638 deployed within the CSP 604. This routing process is guided by the data contained within the traffic packets, allowing the transit gateway 608 to dynamically direct traffic to the appropriate security gateway for inspection. Once the traffic is routed to the security gateways, these gateways undertake the task of inspecting the data packets for any potential malicious threats or security vulnerabilities.

Additionally, security VPC 612, facilitated by the transit gateway 608, can establish underlying VPC peering connections with the VPCs 622-626 hosting the services. Through these peering connections, security VPC 612 can directly communicate with the VPCs 622-626. Furthermore, security VPC 612 modifies routing tables within the transit gateway 608 to ensure that all traffic originating from the services follows the desired routing path to reach each of the respective security gateways security gateway 636-638.

The architecture 600 empowers enterprises with the capability to establish a continuous real-time mode, facilitating the deployment of tag-based security policies alongside the detection of potential malicious threats. This architecture enables enterprises to seamlessly discover VPCs hosting various services and define security policies based on information retained during the discoveries. By leveraging tag-based policies, organizations can implement dynamic and granular security measures tailored to specific attributes and classifications of resources within the cloud environment. The subsequent discussion in FIG. 7-9 elaborates on an example user interface, providing enterprises with a platform to set up CSPs such as the ones described in FIG. 6A-6C with the multi-cloud security controller 644.

FIG. 7 illustrates a user interface for setting up a CSP with a multi-cloud security controller in a cloud security platform in accordance with some aspects of the disclosure.

FIG. 7 illustrates an account setup user interface 700 of the security gateway PaaS, for facilitating the setup of a CSP account within the platform. The account setup user interface 700 is configured to streamline the process for the users, enabling them to establish a secure connection between the gateway and their CSP account.

Upon accessing the account setup user interface 700, the user is presented with a structured process flow designed to seamlessly guide them through each step of the setup process. This process flow aims to configure security settings for the CSP account, catering to the specific requirements of the user. Offering a user-friendly approach, the process flow presents multiple selectable steps, enabling users to initiate or continue the securing of one or more applications associated with a particular CSP account.

In the initial step, labeled connect CSP account 702, users have the option to establish a new connection with a CSP account that has not been previously associated with the platform. This action is facilitated by the connect account button 708, which initiates the setup process for linking the CSP account with the platform.

Moving to the second step, users can opt to enable traffic visibility 704 by selecting the enable visibility button 710. This feature empowers users to gain deeper insights into data traffic by enabling visibility on specific VPCs, thereby enhancing their understanding of the data flow within the specified CSP account.

The third step, denoted as secure CSP account 706, offers users the ability to further enhance the security of the CSP account established in the first step. By selecting the secure account button 712, users can set up a service VPC and deploy a multi-cloud security gateway, bolstering the security measures of the previously linked CSP account in the connect CSP account 702.

Additionally, within the account setup user interface 700, a user can further select additional options from the toolbar 714, including accessing the dashboard, discovering, investigating, and managing resources in the network, and performing administrative tasks related to the security gateway platform.

Additionally, within the account setup user interface 700, users can access a range of additional options from the toolbar 714, expanding the functionality beyond the setup process. These options include accessing the dashboard, which provides a comprehensive overview of the security status and activity within the platform. Furthermore, users can leverage tools for discovering, investigating, and managing resources within the network, empowering them to monitor and optimize the security posture effectively. Moreover, the toolbar facilitates administrative tasks related to the security gateway platform, enabling users to configure settings, manage user permissions, and perform other administrative functions essential for maintaining the platform's integrity and efficiency.

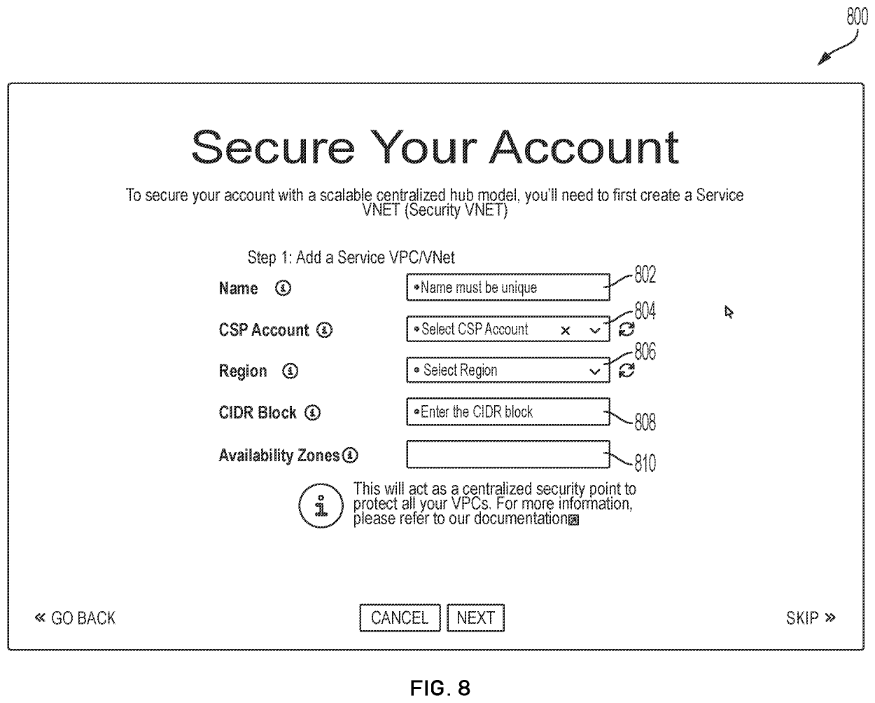

FIG. 8 showcases a user interface tailored for adding a CSP in the cloud security platform in accordance with some aspects of the disclosure. Following the selection of the connect CSP account 702 within the account setup user interface 700 depicted in FIG. 7, users are directed to the secure account user interface 800. Here, the primary objective is to fortify the user's account with the scalable security gateway platform, achieved through the creation of a service Virtual Private Network (VNet) or Virtual Private Cloud (VPC).

The secure account user interface 800 guides users through a structured process, prompting them to input various pieces of information for adding a service VPC or VNet. Users are initially asked to furnish the name 802 of the service VPC being added and the associated CSP account 804. Upon inputting the CSP account 804 information, the interface dynamically populates the region 806 field with one or more regions pertinent to the service and CSP account 804 specified by the user.

Furthermore, users are prompted to input a Classless Inter-Domain Routing (CIDR) 808 in the designated input field. Upon entering this information, the interface automatically populates the availability zones 810 field with a selection of zones available for the added service VPC. This enables users to select the most suitable zone for the service VPC being added, ensuring optimal performance and resource allocation.

The availability zones 810, are dynamically populated based on the selected region 806. Upon selecting a region, users are presented with a range of available zones within that specific region. Utilizing radio buttons, users can then make additional selections based on the populated zones, specifying the exact number of zones they wish to create for the service. This granular level of control allows users to tailor the deployment of their service VPC or VNet precisely to their customizable specifications. By empowering users with the ability to customize the distribution of their resources within the specified regions, the interface enhances flexibility and efficiency in managing and securing their CSP accounts within the platform.

Following the steps outlined above, the security gateway platform creates the VPC in accordance with the user inputs in secure account user interface 800, and subsequently generates subnets within each of the availability zones selected by the user based on their preferences. For every subnet created, distinct routing tables and individual security groups are established. These components are then interconnected to form a cohesive network infrastructure. This combination of resources constitutes the collection of resources being created. While the objective is to maintain uniformity in security measures across all subnets, the actual implementation may vary for each subnet due to the unique characteristics and requirements of the associated zones.

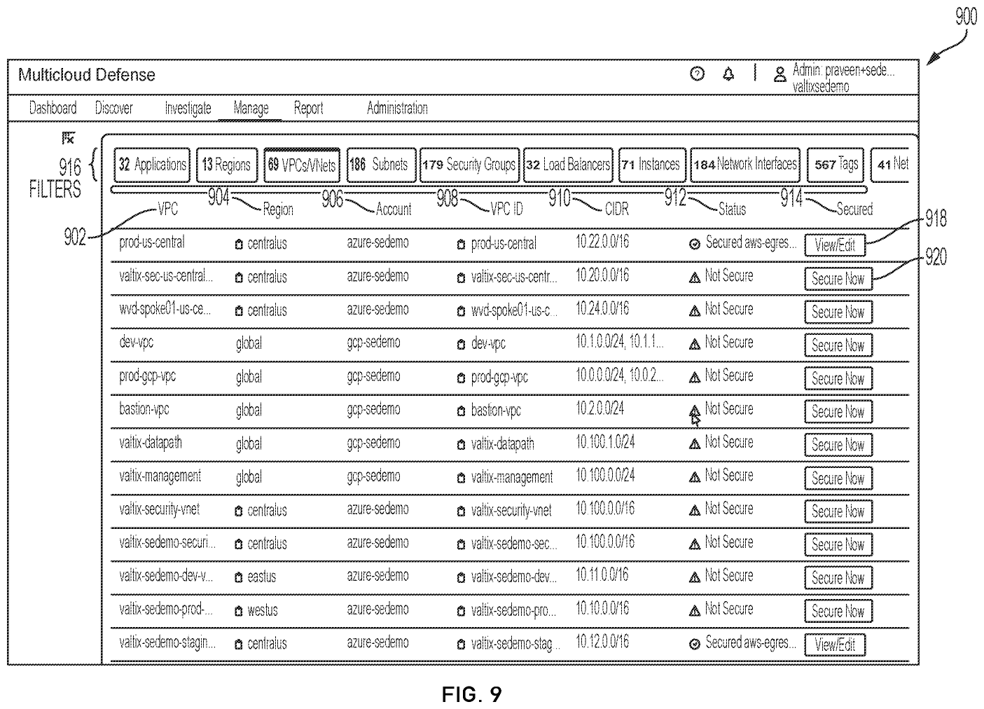

FIG. 9 illustrates an example dashboard providing an inventory of VPCs managed by the cloud security platform in accordance with some aspects of the disclosure.

FIG. 9 illustrates a dashboard that includes a VPC inventory user interface 900 that is generated subsequent to the setup process as described in FIG. 7 and FIG. 8. The VPC inventory user interface 900 serves as a centralized hub providing an inventory of VPCs managed by the gateway platform. Post-setup, the dashboard view encompasses a comprehensive listing of all detected VPCs 902 within the cloud environment. Each VPC entry is accompanied by its corresponding region 904, which is automatically assigned to the VPCs 902, facilitating a streamlined identification of the geographic location. Additionally, the dashboard presents identification information for each of the VPCs 902, including its CIDR 910 and a status 912 of whether each VPC is secure or not secure.

Furthermore, the dashboard features an action button in the secured status 914 that is designated to facilitate user interaction based on the security status 912 of each listed VPC. For VPCs 902 labeled as secured, users are presented with a view/edit option 918 upon selecting the corresponding action button. The view/edit option 918 enables users to access and modify configurations pertinent to the respective VPC and its associated applications, along with reviewing applicable security policies. Conversely, for VPCs 902 listed with a status of not secured, users are presented with a secure now option 920 upon interaction with the corresponding action button. By selecting the secure now option 920, users can initiate the process of securing each desired VPC, streamlining the implementation of security measures to fortify their network infrastructure. This intuitive functionality empowers users to take proactive steps towards enhancing the security posture of their cloud environment directly from the dashboard interface.

Moreover, the dashboard further incorporates filters 916 to enable users to refine and customize the VPC inventory user interface 900 according to their specific security needs for the VPCS 902. These filters 916 functionality provides users with a plethora of filtering criteria, including application, region, VPC/VNet, subnets, security groups, load balancers, instances, network interfaces, tags, and other network categories. By leveraging this comprehensive set of filters, users can precisely define and specify the security settings needed for each VPC supported by the cloud security gateway.

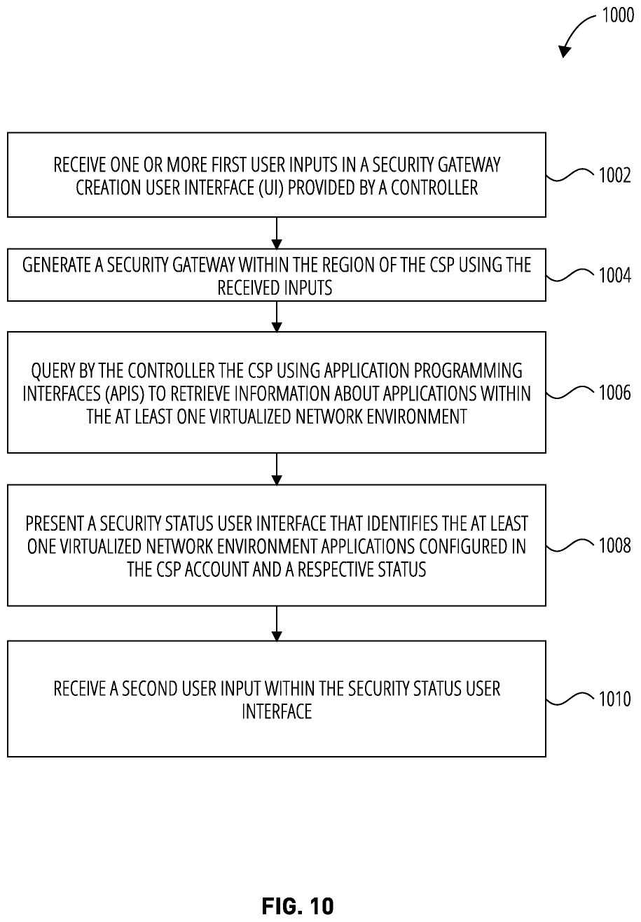

FIG. 10 illustrates a process for creating a security gateway in a cloud service provider (CSP), in accordance with one embodiment. Although the example process 1000 depicts a particular sequence of operations, the sequence may be altered without departing from the scope of the present disclosure. For example, some of the operations depicted may be performed in parallel or in a different sequence that does not materially affect the function of the process 1000. In other examples, different components of an example device or system that implements the process 1000 may perform functions at the same time or in a specific sequence.

According to some examples, the method includes receiving one or more first user inputs in a security gateway creation user interface (UI) provided by a controller at block 1002. For example, the security gateway 638 illustrated in FIG. 6 may receive one or more first user inputs in a security gateway creation user interface (UI) provided by a controller. The one or more first user inputs includes account information for a CSP account and a region within the CSP in which the CSP account has deployed at least one virtualized network environment. The CSP can be any public cloud provider, wherein the virtualized network environment is a virtual private cloud (VPC) or virtual network (VNet). The security gateway creation user interface is configured to maintain consistency regardless of the public cloud provider hosting the CSP account. Through continuous monitoring of the CSP account, the system identifies data originating from new virtualized network environments previously unrecognized by the security gateway. Automatically and without additional user input, the security gateway initiates protection for the new virtualized network environment. The controller takes charge of configuring the new virtualized network environment by establishing a secondary connection to the security gateway and updating routing tables to ensure traffic is directed to the gateway for inspection. Additionally, initial user inputs for the CSP account encompass CIDR blocks, availability zones, authentication credentials, and region information.

According to some examples, the method includes generating a security gateway within the region of the CSP using the received inputs at block 1004.

According to some examples, the method includes querying by the controller the CSP using application programming interfaces (APIs) to retrieve information about applications within the at least one virtualized network environment at block 1006. For example, the multi-cloud security controller 644 illustrated in FIG. 6 may query by the controller the CSP using application programming interfaces (APIs) to retrieve information about applications within the at least one virtualized network environment. The virtualized network environment includes all deployed services within its domain. Querying the CSP to retrieve information about this environment involves obtaining details regarding applications hosted within it. Continuous monitoring of the CSP facilitates the dynamic tracking of changes in application status, virtualized network environments, and the addition of new applications and environments within the CSP account. Subsequently, the security status user interface is updated to reflect these changes and present newly added applications as unprotected, offering the option to enable protection. For an application to be safeguarded by the security gateway, the application resides within a protected virtualized network environment. Upon receiving input from the security status user interface, associating the application with a security policy initiates the inspection of network traffic to and from instances of the application in accordance with the specified policy. Determination of the active application's security policy involves evaluating factors such as data sensitivity, communication protocols, and identified security vulnerabilities.

According to some examples, the method includes presenting a security status user interface that identifies the at least one virtualized network environment applications configured in the CSP account and a respective status at block 1008. For example, the VPC inventory user interface 900 illustrated in FIG. 9 may present a security status user interface that identifies the at least one virtualized network environment applications configured in the CSP account and a respective status. The status of each virtualized network environment indicates whether it is currently safeguarded by the security gateway. Additionally, the security status user interface categorizes these environments into distinct gateway zones, based on their functional dependencies or specific security needs. This zoning allows users to selectively apply security policies to virtualized network environments within each zone. Through continuous monitoring of the CSP account, the system detects data originating from newly identified virtualized network environments not previously protected by the security gateway. These newly detected environments are presented in the security status user interface as unprotected, providing users with the option to enable protection for them.

According to some examples, the method includes receiving a second user input within the security status user interface at block 1010. For example, the VPC inventory user interface 900 illustrated in FIG. 9 may receive a second user input within the security status user interface. The second user input is effective in enabling the protection of at least one virtualized network environment by the security gateway. The controller interacts with one or more APIs appropriate for the respective CSP that is hosting at least one virtualized network environment to configure the respective CSP's particular type of interconnection of the virtualized network environment. In an example, AWS utilizes a transit gateway, Azure utilizes VNet Peering, GCP utilizes VPC Peering.

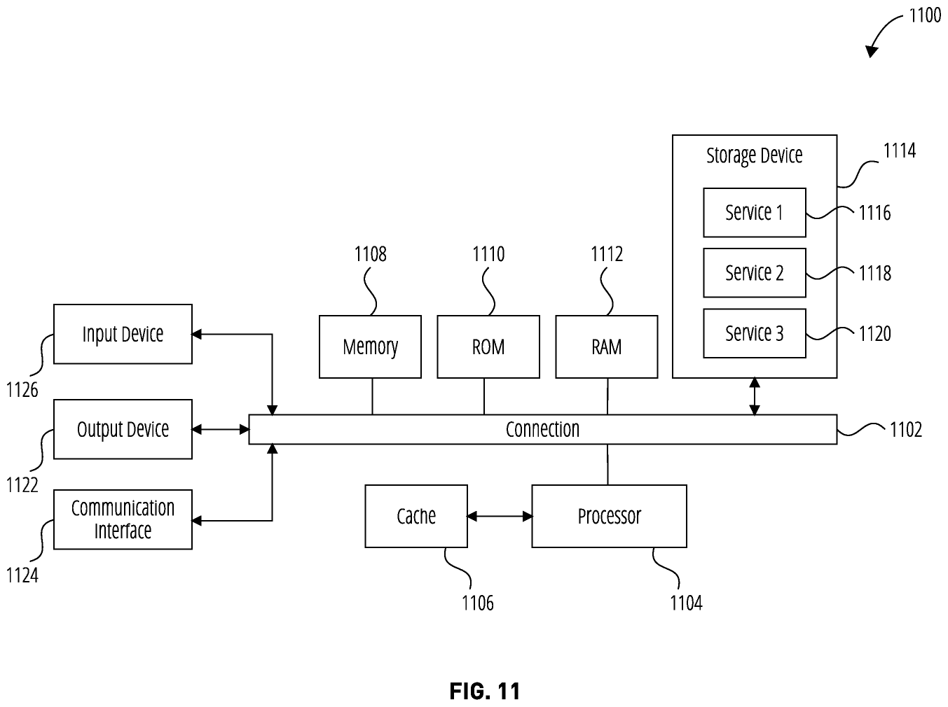

FIG. 11 illustrates an example of computing system 1100, which can be for example any computing device making up a gateway, a controller, a DP agent, a DP worker, or any component thereof in which the components of the system are in communication with each other using connection 1102. Connection 1102 can be a physical connection via a bus, or a direct connection into processor 1104, such as in a chipset architecture. Connection 1102 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1100 includes at least one processing unit (CPU or processor) 1104 and connection 1102 that couples various system components including system memory 1108, such as read-only memory (ROM) 1110 and random-access memory (RAM) 1112 to processor 1104. Computing system 1100 can include a cache 1106 of high-speed memory 1108 connected directly with, in close proximity to, or integrated as part of processor 1104.

Processor 1104 can include any general-purpose processor and a hardware service or software service, such as services 1116, 1118 and 1120, stored in storage device 1114, configured to control processor 1104 as well as a special-purpose processor where software instructions are incorporated into the actual processor design. Processor 1104 may essentially be a completely self-contained computing system, containing multiple cores or processors, a bus, memory controller, cache, etc. A multi-core processor may be symmetric or asymmetric.

To enable user interaction, computing system 1100 includes an input device 1126, which can represent any number of input mechanisms, such as a microphone for speech, a touch-sensitive screen for gesture or graphical input, keyboard, mouse, motion input, speech, etc. Computing system 1100 can also include output device 1122, which can be one or more of a number of output mechanisms known to those of skill in the art. In some instances, multimodal systems can enable a user to provide multiple types of input/output to communicate with computing system 1100. Computing system 1100 can include communication interface 1124, which can generally govern and manage the user input and system output. There is no restriction on operating on any particular hardware arrangement, and therefore the basic features here may easily be substituted for improved hardware or firmware arrangements as they are developed.

Storage device 1114 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1114 can include software services, servers, services, etc., that when the code that defines such software is executed by the processor 1104, it causes the system to perform a function. In some embodiments, a hardware service that performs a particular function can include the software component stored in a computer-readable medium in connection with the necessary hardware components, such as processor 1104, connection 1102, output device 1122, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, universal serial bus (USB) devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. The functionality described herein can also be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Some clauses of the present technology include:

Clause 1. A method for creating a security gateway in a cloud service provider (CSP), comprising: receiving one or more first user inputs in a security gateway creation user interface (UI) provided by a controller, wherein the one or more first user inputs includes account information for a CSP account and a region within the CSP in which the CSP account has deployed at least one virtualized network environment, wherein the CSP can be any public cloud provider, wherein the virtualized network environment is a virtual private cloud (VPC) or virtual network (VNet), wherein the security gateway creation user interface is configured to present a consistent user interface irrespective of which public cloud provider host the CSP account; generating a security gateway within the region of the CSP using the received inputs; querying, by the controller, the CSP using Application Programming Interfaces (APIs) to retrieve information about applications within the at least one virtualized network environment including any services deployed within the at least one virtualized network environment; presenting a security status user interface that identifies the at least one virtualized network environment applications configured in the CSP account and a respective status indicating whether the at least one virtualized network environment is protected by the security gateway; and receiving a second user input within the security status user interface, the second user input is effective to enable protection of the at least one virtualized network environment by the security gateway, wherein the second user input triggers controller to configure the at least one virtualized network environment to create a connection to the security gateway and update routing tables to direct traffic to the security gateway, wherein the controller interacts with one or more APIs appropriate for the respective CSP that is hosting the at least one virtualized network environment to configure the respective CSPs particular type of interconnection of virtualized network environment, for example, AWS utilizes a transit gateway, Azure utilizes VNet Peering, GCP utilizes VPC Peering.

Clause 2. The method of clause 1, wherein the security status user interface further categorizes the at least one virtualized network environment into multiple gateway zones based on their functional dependencies or security requirements, allowing users to selectively apply security policies to respective virtualized network environments within specific zones.

Clause 3. The method of clause 1, further comprising: detecting, through continuous monitoring of the CSP account, data originating from a new virtualized network environment not previously identified in the security gateway; presenting the new virtualized network environment in the security status user interface as not protected along with an option to protect the new virtualized network environment.

Clause 4. The method of clause 1, further comprising: detecting, through continuous monitoring of the CSP account, data originating from a new virtualized network environment not previously identified in the security gateway; automatically, without further user interaction, enabling protection of the new virtualized network environment by the security gateway, wherein the controller configures the new virtualized network environment to create a second connection to the security gateway and update routing tables to direct traffic to the security gateway.

Clause 5. The method of clause 1, wherein the querying the CSP to retrieve information about the at least one virtualized network environment includes retrieving information about an application hosted within the at least one virtualized network environment.

Clause 6. The method of clause 5, further comprising: monitoring the CSP to dynamically to learn of changes in the status of the application, the at least one virtualized network environments, and new applications and new virtualized network environments within the CSP account; and updating the security status user interface with the changes in the status and the new applications and new virtualized network environments.

Clause 7. The method of clause 5, further comprising: presenting the application in the security status user interface as not protected along with an option to protect the application, wherein the application needs to be within a protected virtualized network environment in order to be protected by the security gateway; receiving an input by the security status user interface to associate the application with a security policy, whereby network traffic to and from instances of the application will be inspected by the security gateway according to the security policy.

Clause 8. The method of clause 1, wherein the security policy assigned to the active application is determined by evaluating the security information provided by the active application, taking into account factors such as data sensitivity, communication protocols, and one or more security vulnerabilities.

Clause 9. The method of clause 1, wherein the first user inputs for the CSP account includes CIDR blocks, and availability zones in addition to the authentication credentials and region.

Clause 10. A network device comprising: a transceiver; a processor configured to execute instructions and cause the processor to: receive one or more first user inputs in a security gateway creation user interface (UI) provided by a controller, wherein the one or more first user inputs includes account information for a CSP account and a region within the CSP in which the CSP account has deployed at least one virtualized network environment, wherein the CSP can be any public cloud provider, wherein the virtualized network environment is a virtual private cloud (VPC) or virtual network (VNet), wherein the security gateway creation user interface is configured to present a consistent user interface irrespective of which public cloud provider host the CSP account; generate a security gateway within the region of the CSP using the received inputs; query, by the controller, the CSP using Application Programming Interfaces (APIs) to retrieve information about applications within the at least one virtualized network environment including any services deployed within the at least one virtualized network environment; present a security status user interface that identifies the at least one virtualized network environment applications configured in the CSP account and a respective status indicating whether the at least one virtualized network environment is protected by the security gateway; and receive a second user input within the security status user interface, the second user input is effective to enable protection of the at least one virtualized network environment by the security gateway, wherein the second user input triggers controller to configure the at least one virtualized network environment to create a connection to the security gateway and update routing tables to direct traffic to the security gateway, wherein the controller interacts with one or more APIs appropriate for the respective CSP that is hosting the at least one virtualized network environment to configure the respective CSPs particular type of interconnection of virtualized network environment, for example, AWS utilizes a transit gateway, Azure utilizes VNet Peering, GCP utilizes VPC Peering.

Clause 11. The computing apparatus of clause 1, wherein the security status user interface further categorizes the at least one virtualized network environment into multiple gateway zones based on their functional dependencies or security requirements, allow users to selectively apply security policies to respective virtualized network environments within specific zones.

Clause 12. The computing apparatus of clause 1, wherein the instructions further configure the apparatus to: detect, through continuous monitoring of the CSP account, data originating from a new virtualized network environment not previously identified in the security gateway; present the new virtualized network environment in the security status user interface as not protected along with an option to protect the new virtualized network environment.

Clause 13. The computing apparatus of clause 1, wherein the instructions further configure the apparatus to: detect, through continuous monitoring of the CSP account, data originating from a new virtualized network environment not previously identified in the security gateway; automatically, without further user interaction, enable protection of the new virtualized network environment by the security gateway, wherein the controller configures the new virtualized network environment to create a second connection to the security gateway and update routing tables to direct traffic to the security gateway.

Clause 14. The computing apparatus of clause 1, wherein the querying the CSP to retrieve information about the at least one virtualized network environment includes retrieve information about an application hosted within the at least one virtualized network environment.

Clause 15. The computing apparatus of clause 5, wherein the instructions further configure the apparatus to: monitor the CSP to dynamically to learn of changes in the status of the application, the at least one virtualized network environments, and new applications and new virtualized network environments within the CSP account; and update the security status user interface with the changes in the status and the new applications and new virtualized network environments.

Clause 16. The computing apparatus of clause 5, wherein the instructions further configure the apparatus to: present the application in the security status user interface as not protected along with an option to protect the application, wherein the application needs to be within a protected virtualized network environment in order to be protected by the security gateway; receive an input by the security status user interface to associate the application with a security policy, whereby network traffic to and from instances of the application will be inspected by the security gateway according to the security policy.

Clause 17. The computing apparatus of clause 1, wherein the security policy assigned to the active application is determined by evaluating the security information provided by the active application, take into account factors such as data sensitivity, communication protocols, and one or more security vulnerabilities.

Clause 18. The computing apparatus of clause 1, wherein the first user inputs for the CSP account includes CIDR blocks, and availability zones in addition to the authentication credentials and region.

Clause 19. A non-transitory computer readable medium comprising instructions, the instructions, when executed by a computing system, cause the computing system to: receive one or more first user inputs in a security gateway creation user interface (UI) provided by a controller, wherein the one or more first user inputs includes account information for a CSP account and a region within the CSP in which the CSP account has deployed at least one virtualized network environment, wherein the CSP can be any public cloud provider, wherein the virtualized network environment is a virtual private cloud (VPC) or virtual network (VNet), wherein the security gateway creation user interface is configured to present a consistent user interface irrespective of which public cloud provider host the CSP account; generate a security gateway within the region of the CSP using the received inputs; query, by the controller, the CSP using Application Programming Interfaces (APIs) to retrieve information about applications within the at least one virtualized network environment including any services deployed within the at least one virtualized network environment; present a security status user interface that identifies the at least one virtualized network environment applications configured in the CSP account and a respective status indicating whether the at least one virtualized network environment is protected by the security gateway; and receive a second user input within the security status user interface, the second user input is effective to enable protection of the at least one virtualized network environment by the security gateway, wherein the second user input triggers controller to configure the at least one virtualized network environment to create a connection to the security gateway and update routing tables to direct traffic to the security gateway, wherein the controller interacts with one or more APIs appropriate for the respective CSP that is hosting the at least one virtualized network environment to configure the respective CSPs particular type of interconnection of virtualized network environment, for example, AWS utilizes a transit gateway, Azure utilizes VNet Peering, GCP utilizes VPC Peering.

Clause 20. The computer-readable storage medium of clause 1, wherein the security status user interface further categorizes the at least one virtualized network environment into multiple gateway zones based on their functional dependencies or security requirements, allow users to selectively apply security policies to respective virtualized network environments within specific zones.

Clause 21. The computer-readable storage medium of clause 1, wherein the instructions further configure the computer to: detect, through continuous monitoring of the CSP account, data originating from a new virtualized network environment not previously identified in the security gateway; and present the new virtualized network environment in the security status user interface as not protected along with an option to protect the new virtualized network environment.

Clause 22. The computer-readable storage medium of clause 1, wherein the instructions further configure the computer to: detect, through continuous monitoring of the CSP account, data originating from a new virtualized network environment not previously identified in the security gateway; automatically, without further user interaction, enable protection of the new virtualized network environment by the security gateway, wherein the controller configures the new virtualized network environment to create a second connection to the security gateway and update routing tables to direct traffic to the security gateway.

Clause 23. The computer-readable storage medium of clause 1, wherein the querying the CSP to retrieve information about the at least one virtualized network environment includes retrieve information about an application hosted within the at least one virtualized network environment.

Clause 24. The computer-readable storage medium of clause 5, wherein the instructions further configure the computer to: monitor the CSP to dynamically to learn of changes in the status of the application, the at least one virtualized network environments, and new applications and new virtualized network environments within the CSP account; and update the security status user interface with the changes in the status and the new applications and new virtualized network environments.

Clause 25. The computer-readable storage medium of clause 5, wherein the instructions further configure the computer to: present the application in the security status user interface as not protected along with an option to protect the application, wherein the application needs to be within a protected virtualized network environment in order to be protected by the security gateway; receive an input by the security status user interface to associate the application with a security policy, whereby network traffic to and from instances of the application will be inspected by the security gateway according to the security policy.

Clause 26. The computer-readable storage medium of clause 1, wherein the security policy assigned to the active application is determined by evaluating the security information provided by the active application, take into account factors such as data sensitivity, communication protocols, and one or more security vulnerabilities.

Clause 27. The computer-readable storage medium of clause 1, wherein the first user inputs for the CSP account includes CIDR blocks, and availability zones in addition to the authentication credentials and region.

What is claimed is:

1. A method for creating a security gateway in a cloud service provider (CSP), comprising:
receiving one or more first user inputs in a security gateway creation user interface (UI) provided by a controller, wherein the one or more first user inputs includes account information for a CSP account and a region within the CSP in which the CSP account has deployed at least one virtualized network environment;
generating a security gateway within a region of the CSP using the received inputs;
querying, by the controller, the CSP using Application Programming Interfaces (APIs) to retrieve information about applications within the at least one virtualized network environment;
presenting a security status user interface that identifies the at least one virtualized network environment applications configured in the CSP account and a respective status indicating whether the at least one virtualized network environment is protected by the security gateway; and
receiving a second user input within the security status user interface, the second user input is effective to enable protection of the at least one virtualized network environment by the security gateway, wherein the second user input triggers the controller to configure the at least one virtualized network environment to create a connection to the security gateway and update routing tables to direct traffic to the security gateway.

2. The method of claim 1, wherein the security status user interface further categorizes the at least one virtualized network environment into multiple gateway zones based on their functional dependencies or security requirements, allowing users to selectively apply security policies to respective virtualized network environments within specific zones.

3. The method of claim 1, further comprising:
detecting, through continuous monitoring of the CSP account, data originating from a new virtualized network environment not previously identified in the security gateway; and
presenting the new virtualized network environment in the security status user interface as not protected along with an option to protect the new virtualized network environment.

4. The method of claim 1, further comprising:
detecting, through continuous monitoring of the CSP account, data originating from a new virtualized network environment not previously identified in the security gateway; and
automatically, without further user interaction, enabling protection of the new virtualized network environment by the security gateway, wherein the controller configures the new virtualized network environment to create a second connection to the security gateway and update routing tables to direct traffic to the security gateway.

5. The method of claim 1, further comprising:
monitoring the CSP to dynamically to learn of changes in the status of the application, the at least one virtualized network environments, and new applications and new virtualized network environments within the CSP account; and
updating the security status user interface with the changes in the status and the new applications and new virtualized network environments.

6. The method of claim 1, further comprising:
presenting the application in the security status user interface as not protected along with an option to protect the application, wherein the application needs to be within a protected virtualized network environment in order to be protected by the security gateway; and
receiving an input by the security status user interface to associate the application with a security policy, whereby network traffic to and from instances of the application will be inspected by the security gateway according to the security policy.

7. The method of claim 1, wherein a security policy assigned to an active application is determined by evaluating the security information provided by the active application, taking into account factors such as data sensitivity, communication protocols, and one or more security vulnerabilities.

8. A network device comprising:
a transceiver; and
a processor configured to execute instructions and cause the processor to:
receive one or more first user inputs in a security gateway creation user interface (UI) provided by a controller, wherein the one or more first user inputs includes account information for a CSP account and a region within the CSP in which the CSP account has deployed at least one virtualized network environment;
generate a security gateway within a region of the CSP using the received inputs;
query, by the controller, the CSP using Application Programming Interfaces (APIs) to retrieve information about applications within the at least one virtualized network environment;
present a security status user interface that identifies the at least one virtualized network environment applications configured in the CSP account and a respective status indicating whether the at least one virtualized network environment is protected by the security gateway; and
receive a second user input within the security status user interface, the second user input is effective to enable protection of the at least one virtualized network environment by the security gateway, wherein a second user input triggers controller to configure the at least one virtualized network environment to create a connection to the security gateway and update routing tables to direct traffic to the security gateway.

9. The network device of claim 8, wherein the security status user interface further categorizes the at least one virtualized network environment into multiple gateway zones based on their functional dependencies or security requirements, allow users to selectively apply security policies to respective virtualized network environments within specific zones.

10. The network device of claim 8, wherein the instructions further configure the network device to:
detect, through continuous monitoring of the CSP account, data originating from a new virtualized network environment not previously identified in the security gateway; and
present the new virtualized network environment in the security status user interface as not protected along with an option to protect the new virtualized network environment.

11. The network device of claim 8, wherein the instructions further configure the network device to:
detect, through continuous monitoring of the CSP account, data originating from a new virtualized network environment not previously identified in the security gateway; and
automatically, without further user interaction, enable protection of the new virtualized network environment by the security gateway, wherein the controller configures the new virtualized network environment to create a second connection to the security gateway and update routing tables to direct traffic to the security gateway.

12. The network device of claim 8, wherein the instructions further configure the network device to:
monitor the CSP to dynamically to learn of changes in the status of the application, the at least one virtualized network environments, and new applications and new virtualized network environments within the CSP account; and
update the security status user interface with the changes in the status and the new applications and new virtualized network environments.

13. The network device of claim 8, wherein the instructions further configure the network device to:
present the application in the security status user interface as not protected along with an option to protect the application, wherein the application needs to be within a protected virtualized network environment in order to be protected by the security gateway; and
receive an input by the security status user interface to associate the application with a security policy, whereby network traffic to and from instances of the application will be inspected by the security gateway according to the security policy.

14. The network device of claim 8, wherein a security policy assigned to an active application is determined by evaluating the security information provided by the active application, take into account factors such as data sensitivity, communication protocols, and one or more security vulnerabilities.

15. A non-transitory computer-readable medium comprising instructions, the instructions, when executed by a computing system, cause the computing system to:
receive one or more first user inputs in a security gateway creation user interface (UI) provided by a controller, wherein the one or more first user inputs includes account information for a CSP account and a region within the CSP in which the CSP account has deployed at least one virtualized network environment;
generate a security gateway within a region of the CSP using the received inputs;
query, by the controller, the CSP using Application Programming Interfaces (APIs) to retrieve information about applications within the at least one virtualized network environment;
present a security status user interface that identifies the at least one virtualized network environment applications configured in the CSP account and a respective status indicating whether the at least one virtualized network environment is protected by the security gateway; and
receive a second user input within the security status user interface, the second user input is effective to enable protection of the at least one virtualized network environment by the security gateway, wherein the second user input triggers the controller to configure the at least one virtualized network environment to create a connection to the security gateway and update routing tables to direct traffic to the security gateway.

16. The non-transitory computer-readable medium of claim 15, wherein the security status user interface further categorizes the at least one virtualized network environment into multiple gateway zones based on their functional dependencies or security requirements, allowing users to selectively apply security policies to respective virtualized network environments within specific zones.

17. The non-transitory computer-readable medium of claim 15, wherein the computer-readable medium further comprises instructions that, when executed by the computing system, cause the computing system to:
detect, through continuous monitoring of the CSP account, data originating from a new virtualized network environment not previously identified in the security gateway; and
present the new virtualized network environment in the security status user interface as not protected along with an option to protect the new virtualized network environment.

18. The non-transitory computer-readable medium of claim 15, wherein the instructions further configure the computer to:
detect, through continuous monitoring of the CSP account, data originating from a new virtualized network environment not previously identified in the security gateway; and
automatically, without further user interaction, enable protection of the new virtualized network environment by the security gateway, wherein the controller configures the new virtualized network environment to create a second connection to the security gateway and update routing tables to direct traffic to the security gateway.

19. The non-transitory computer-readable medium of claim 15, wherein the computer-readable medium further comprises instructions that, when executed by the computing system, cause the computing system to:
monitor the CSP to dynamically to learn of changes in the status of the application, the at least one virtualized network environments, and new applications and new virtualized network environments within the CSP account; and
update the security status user interface with the changes in the status and the new applications and new virtualized network environments.

20. The non-transitory computer-readable medium of claim 15, wherein the computer-readable medium further comprises instructions that, when executed by the computing system, cause the computing system to:
present the application in the security status user interface as not protected along with an option to protect the application, wherein the application needs to be within a protected virtualized network environment in order to be protected by the security gateway; and
receive an input by the security status user interface to associate the application with a security policy, whereby network traffic to and from instances of the application will be inspected by the security gateway according to the security policy.
